(19) United States
(12) Patent Application Publication
(10) Pub. No.: US 2014/0010981 A1
(43) Pub. Date: Jan. 9, 2014

(54) PRODUCING FOAMS HAVING IMPROVED PROPERTIES

(71) Applicant: BASF SE, Ludwigshafen (DE)

(72) Inventors: Christof GRIESER-SCHMITZ, Osnabrueck (DE); Gianpaolo Tomasi, Diepholz (DE); Ludwig Windeler, Marl (DE); Alex Popov, Lemfoerde (DE); Carsten Ellersiek, Lengerich (DE); Annika Halwe-Bommelmann, Rahden-Varl (DE)

(73) Assignee: BASF SE, Ludwigshafen (DE)

(21) Appl. No.: 13/923,959

(22) Filed: Jun. 21, 2013

Related U.S. Application Data
(60) Provisional application No. 61/667,957, filed on Jul. 4, 2012.
(60) Provisional application No. 61/697,820, filed on Sep. 7, 2012.

(51) Int. Cl. C08G 18/72; F16L 59/02; B29C 44/18; C08L 75/08; C08G 18/08

(52) U.S. Cl. CPC C08G 18/72; C08L 75/08; C08G 18/14; B29C 44/18; F16L 59/028
USPC 428/36.5; 521/159; 521/131; 252/62; 264/46.9

(57) ABSTRACT

The present invention relates to a composition for producing a rigid polyurethane foam comprising at least one polyol having a molecular weight of not less than 1700 g/mol and at least one blowing agent as component A, and at least one polyisocyanate as component B, wherein the at least one polyisocyanate B comprises from 11 to 39.5 wt % of a polyisocyanate prepolymer, based on a polyether polyol having an OH number of at least 100 mg KOH/g, to a rigid polyurethane foam obtainable by reacting this composition, to a process for producing such a rigid polyurethane foam, to the use of such a rigid polyurethane foam for insulation, especially for pipe insulation and also to a process for producing an insulated pipe.

The present invention relates to a composition for producing a rigid polyurethane foam comprising at least one polyol having a molecular weight of not less than 1700 g/mol and at least one blowing agent as component A, and at least one polyisocyanate as component B, wherein the at least one polyisocyanate B comprises from 11 to 39.5 wt % of a polyisocyanate prepolymer, based on a polyether polyol having an OH number of at least 100 mg KOH/g, to a rigid polyurethane foam obtainable by reacting this composition, to a process for producing such a rigid polyurethane foam, to the use of such a rigid polyurethane foam for insulation, especially for pipe insulation, to an insulated pipe comprising a rigid polyurethane foam and also to a process for producing an insulated pipe.

Compositions for producing a polyurethane foam and the foams are already known from the prior art.

WO 01/18087 A1 discloses a polyol composition comprising a specific mixture of various polyols for producing semi-flexible rigid polyurethane foams. Useful polyisocyanate components for these polyurethane foams include the common general knowledge polyisocyanates such as 2,4-tolylene diisocyanate, 4,4′-diphenylmethane diisocyanate and polymeric 4,4′-diphenylmethane diisocyanate and also isomers and mixtures thereof.

EP 0 906 354 B2 discloses a process for producing rigid polyurethane foams by reacting polyisocyanates with isocyanate-reactive compounds. Useful isocyanate-reactive components include various polyols based on polyfunctional alcohols and/or amines. Useful polyisocyanate components likewise include the customary polyisocyanates such as diphenylmethane diisocyanates.

DE 698 03 793 T2 discloses polyol formulations for producing polyurethane foams. The polyol formulations as per this document comprise a specific mixture of two different polyols which differ inter alia in molecular weight. Useful polyisocyanate components for reaction with this polyol mixture to form rigid polyurethane foams include the known polyisocyanates such as 2,4-tolylene diisocyanate, 4,4′-diphenylmethane diisocyanate and polymeric 4,4′-diphenylmethane diisocyanate and also isomers and mixtures thereof.

EP 0 320 134 A1 discloses polyisocyanate compositions for producing polyurethane foams. The specific polyisocyanate composition comprises 3 to 27 wt % of a prepolymer of diphenylmethane diisocyanate and a compound comprising two or more isocyanate-reactive groups having a molecular weight below 1000 g/mol.

DE 101 08 443 A1 discloses a pressure vessel containing reaction products for producing an elastic foam. The reaction product comprises at least an isocyanate and a mixture of polyether polyols. Useful isocyanate components are said to include customary isocyanates such as 2,4-tolylene diisocyanate, 4,4′-diphenylmethane diisocyanate and polymeric 4,4′-diphenylmethane diisocyanate and also isomers and mixtures thereof, and also reaction products of at least one isocyanate-reactive compound with at least one di- and/or polyisocyanate, so-called prepolymers. What is disclosed in the cited document is a flexible and not a rigid polyurethane foam.

DE 196 10 262 A1 discloses a process for producing hydrocarbon-blown rigid polyurethane foams. A composition comprising polyols and polyisocyanates as well as blowing agent is reacted and foamed up. The polyol component comprises 60 to 100% of polyethers and/or polyesters having a molecular weight of 250 to 1500 g/mol and two or more hydroxyl groups, as well as iso- and/or n-pentane as blowing agent.

Prior art rigid polyurethane foams are in need of improvement in respect of their flexibility. The preferably continuous production of insulated pipes requires that the pipes produced be wound up on rolls for transportation. The rigid polyurethane foam used as insulation has to be sufficiently flexible not to break during winding.

The present invention therefore has for its object to provide a rigid polyurethane foam having particularly good insulating properties and a sufficiently high flexibility so that the continuously produced insulated pipes may be wound up continuously. The present invention therefore has the more particular object of providing a composition for producing such rigid polyurethane foams, the rigid polyurethane foams, a process for their production and also for the use of rigid polyurethane foams obtained for insulation purposes.

These objects are achieved according to the present invention by the composition for producing a rigid polyurethane foam at least comprising:
(A) at least one polyol having a molecular weight of not less than 1700 g/mol and at least one blowing agent as component A, and
(B) at least one polyisocyanate as component B,
   wherein the at least one polyisocyanate B comprises from 11 to 39.5 wt % of a polyisocyanate prepolymer based on at least a polyether polyol having an OH number of at least 100.

In a further embodiment, the present invention relates to a composition for producing a rigid polyurethane foam at least comprising:
(A) at least one polyol having a molecular weight of not less than 1700 g/mol and at least one blowing agent as component A, and
(B) at least one polyisocyanate as component B,
   wherein the at least one polyisocyanate comprises from 40 to 100 wt % of a polyisocyanate prepolymer.

The present invention relates to a composition for producing a rigid polyurethane foam. The term rigid polyurethane foam for the purposes of the present invention relates to a foam which comprises at least a polyurethane; it is more preferable for the rigid polyurethane foam of the present invention to consist of polyurethane.

The term “rigid foam” is well known to a person skilled in the art and describes, in general, foams having rigid, close-mesh, crosslinked polymeric structures. Rigid foams are closed-cell foams having discrete cells in the foam which are divided from each other by the polymer matrix. They are notable for good thermal insulation performance.

The rigid polyurethane foam of the present invention preferably has a compressive stress at 10% relative deformation of not less than 50 kPa, more preferably not less than 100 kPa, very preferably not less than 150 kPa. Furthermore, the rigid polyurethane foam of the present invention preferably has a DIN ISO 4590 closed-cell content of at least 70%, more preferably greater than 85%. Further details concerning rigid polyurethane foams of the present invention appear in “Kunststoffhandbuch, vol. 7, Polyurethane”, Carl Hanser Verlag, 3rd edition 1993, chapter 6. DIN 7726 can also be referenced for polyurethane foams.

The individual components of the composition according to the present invention will now be elucidated in detail:

### Component A:

The present invention composition for producing a rigid polyurethane foam comprises a component A comprising at least one polyol having a molecular weight of not less than 1700 g/mol and at least one blowing agent.

In general, any polyol suitable for producing a rigid polyurethane foam can be used for the purposes of the present invention. The present invention utilizes at least one polyol having a molecular weight of not less than 1700 g/mol, preferably not less than 2500 g/mol and more preferably not less than 4000 g/nnol, for example 4350 g/moi. An upper limit to the molecular weight of the at least one polyols is generally 8000 g/mol, preferably 7000 g/mol and more preferably 6000 g/mol.

Useful polyols for the purposes of the present invention include in general compounds having two or more isocyanate-reactive groups, i.e., having two or more hydrogen atoms that are reactive with isocyanate groups. Examples thereof are compounds having OH groups, SH groups, NH groups and/or NH₂ groups.

Preferred polyols for the purposes of the present invention are compounds based on polyesterols or polyetherols, preferably polyetherols. Polyetherol and/or polyesterol functionality is generally in the range from 1.5 to 8, preferably in the range from 1.7 to 7 and more preferably in the range from 1.9 to 6.

The polyols have a hydroxyl number (OH number) of generally greater than 10 mg KOH/g, preferably greater than 15 mg KOH/g and more preferably greater than 20 mg KOH/g. The upper limit to the hydroxyl number is generally 1000 mg KOH/g, preferably 900 mg KOH/g, particularly 700 mg KOH/g.

It is preferable for the purposes of the present invention for the at least one polyol present in component A to utilize a mixture of polyols, for example comprising two, three, four or more different polyols, for example polyetherols and/or polyesterols, preferably polyetherols.

When, as is preferred for the purposes of the present invention, a polyol mixture is used, the OH numbers stated above are based on the polyol mixture in total, which does not foreclose the possibility that individual constituents making up the mixture have higher or lower values. It is, for example, preferable for the purposes of the present invention for there to be at least one polyol in the mixture that has a hydroxyl number of 10 to 80 mg KOH/g and preferably of 15 to 60 mg KOH/g.

Component A preferably comprises polyether polyols obtained by known methods, for example by anionic polymerization of alkali metal hydroxides, such as sodium hydroxide or potassium hydroxide, or alkali metal alkoxides, such as sodium methoxide, sodium ethoxide, potassium ethoxide or potassium isopropoxide, as catalysts and by adding at least one starter molecule comprising from 2 to 8 and preferably from 3 to 8 reactive hydrogen atoms in bonded form, or by cationic polymerization with Lewis acids, such as antimony pentachloride, boron fluoride etherate inter alia or fuller's earth as catalysts from one or more alkylene oxides having 2 to 4 carbon atoms in the alkylene moiety.

Useful alkylene oxides include for example tetrahydrofuran, 1,3-propylene oxide, 1,2-butylene oxide, 2,3-butylene oxide, styrene oxide and preferably ethylene oxide and 1,2-propylene oxide. The alkylene oxides can be used singly, alternatingly in succession or as mixtures.

Useful starter compounds for the polyols in the composition of the present invention include alcohols, sugar compounds, amines, condensation products of at least one amine, at least one aromatic compound and formaldehyde, and mixtures thereof.

The present invention therefore relates with preference to that composition of the present invention wherein component A comprises at least one polyol based on a compound selected from the group consisting of alcohols, sugar compounds, amines, condensation products of at least one amine, at least one aromatic compound and formaldehyde, and mixtures thereof.

Useful starter molecules include alcohols, for example glycerol, trimethylolpropane (TMP), pentaerythritol, diethylene glycol, sugar compounds, for example sucrose, sorbitol, and also amines, for example methylamine, ethylamine, isopropylamine, butylamine, benzylamine, aniline, toluidine, tolylenediamine (TDA), naphthyleneamine, ethylenediamine (EDA), diethylenetriamine, 4,4′-methylenedianiline, 1,3-propanediamine, 1,6-hexanediamine, ethanolamine, diethanolamine, triethanolamine and the like.

Useful starter molecules further include condensation products of at least one amine, of at least one aromatic compound and formaldehyde, especially condensation products of formaldehyde, phenol and diethanolamine/ethanolamine; formaldehyde, alkylphenols and diethanolamine/ethanolamine; formaldehyde, bisphenol A and diethanolamine/ethanolamine; formaldehyde, aniline and diethanolamine/ethanolamine; formaldehyde, kresol and diethanolamine/ethanolamine, formaldehyde, toluidine and diethanolamine/ethanolamine; and formaldehyde, tolylenediamine (TDA) and diethanolamine/ethanolamine; and the like.

Very particular preference is given to using starter molecules selected from the group consisting of glycerol, tolylenediamine (TDA), sucrose, pentaerythritol, diethylene glycol, trimethylolpropane (TMP), ethylenediamine, sorbitol and mixtures thereof.

It is particularly preferable for component A of the composition according to the present invention to comprise a mixture of two or more polyols, most preferably three polyols, especially polyetherols.

In a particularly preferred embodiment, component A of the composition according to the present invention comprises two different polyetherols a1 and a2.

It is accordingly particularly preferable for the present invention to relate to that composition according to the present invention wherein component A comprises a polyetherol mixture comprising at least one polyetherol a1 based on at least one trihydric alcohol, especially glycerol, at least one polyetherol a2 based on at least one amine, especially tolylenediamine (TDA). In a further particularly preferred embodiment, component A of the composition according to the present invention comprises three different polyetherols a1, a2 and a3.

Therefore, in a further particularly preferred embodiment, the present invention relates to that composition according to the present invention wherein component A comprises a polyetherol mixture comprising at least one polyetherol a1 based on at least one trihydric alcohol, especially glycerol, at least one polyetherol a2 based on at least one amine, especially tolylenediamine (TDA), and at least one polyetherol a3 based on at least one sugar compound, especially based on a mixture comprising sucrose, pentaerythritol and diethylene glycol.

The preferred polyetherol a1 is based on at least one trihydric alcohol, especially glycerol.

It is further preferable for polyetherol a1 to be alkoxylated with at least one alkylene oxide, preferably propylene oxide and/or ethylene oxide, preferably with propylene oxide and ethylene oxide.

It is preferable for the purposes of the present invention for polyetherol a1 to have a molecular weight of not less than 1700 g/mol. The molecular weight of polyetherol a1 is for example in the range from 1700 to 8000 g/mol, preferably in the range from 2200 to 7000 g/mol and more preferably in the range from 3000 to 6000 g/mol, for example 4350 g/mol.

The hydroxyl number (OH number) of polyetherol a1 is for example in the range from 10 to 80 mg KOH/g, preferably in the range from 15 to 60 mg KOH/g and more preferably in the range from 25 to 45 mg KOH/g.

The functionality of polyetherol a1 is for example in the range from 1.5 to 6, preferably in the range from 1.7 to 5 and more preferably in the range from 1.9 to 4.5.

The preferred polyether polyol a1 is obtainable by following methods known to a person skilled in the art and mentioned above.

The preferred polyetherol a2 is based on at least one amine, especially tolylenediamine (TDA).

It is further preferable for the polyetherol a2 to be alkoxylated with at least one alkylene oxide, preferably propylene oxide and/or ethylene oxide, preferably propylene oxide and ethylene oxide.

The molecular weight of polyetherol a2 is for example in the range from 200 to 2000 g/mol, preferably in the range from 250 to 1500 g/mol and more preferably in the range from 300 to 1000 g/mol, for example 530 g/mol.

The hydroxyl number (OH number) of polyetherol a2 is for example in the range from 100 to 600 mg KOH/g, preferably in the range from 120 to 500 mg KOH/g and more preferably in the range from 150 to 450 mg KOH/g.

The functionality of polyetherol a2 is for example in the range from 2.0 to 5.0, preferably in the range from 2.5 to 4.5 and more preferably in the range from 3.0 to 4.2.

The preferred polyether polyol a2 is obtainable by following methods known to a person skilled in the art and mentioned above.

The preferred polyetherol a3 is preferably based on a mixture comprising sucrose, pentaerythritol, diethylene glycol.

It is further preferable for the polyetherol a3 to be alkoxylated with at least one alkylene oxide, preferably propylene oxide and/or ethylene oxide, preferably propylene oxide.

The molecular weight of polyetherol a3 is for example in the range from 200 to 2000 g/mol, preferably in the range from 300 to 1500 g/mol and more preferably in the range from 400 to 1000 g/mol, for example 545 g/mol.

The hydroxyl number (OH number) of polyetherol a3 is for example in the range from 100 to 600 mg KOH/g, preferably in the range from 200 to 500 mg KOH/g and more preferably in the range from 300 to 450 mg KOH/g.

The functionality of polyetherol a3 is for example in the range from 2.0 to 6.0, preferably in the range from 2.5 to 5.5 and more preferably in the range from 3.0 to 5.2.

The preferred polyether polyol a3 is obtainable by following methods known to a person skilled in the art and mentioned above.

The amount of polyether polyol a1 in the mixture of recited polyether polyols a1, a2 and a3, the use of which is preferred according to the present invention, is for example in the range from 30 to 60 wt %, preferably in the range from 35 to 50 wt % and more preferably in the range from 38 to 45 wt %, all based on the mixture comprising a1, a2 and a3.

The amount of polyether polyol a2 in the mixture of recited polyether polyols a1, a2 and a3, the use of which is preferred according to the present invention, is for example in the range from 10 to 40 wt %, preferably in the range from 20 to 40 wt % and more preferably in the range from 25 to 35 wt %, all based on the mixture comprising a1, a2 and a3.

The amount of polyether polyol a3 in the mixture of recited polyether polyols a1, a2 and a3, the use of which is preferred according to the present invention, is for example in the range from 10 to 40 wt %, preferably in the range from 20 to 40 wt % and more preferably in the range from 22 to 35 wt %, all based on the mixture comprising a1, a2 and a3.

The amounts of a1, a2, a3 and any stabilizer and/or water add up to 100 wt % according to the present invention.

In a further preferred embodiment of the present invention, component A of the composition according to the present invention comprises at least one additive selected from the group consisting of chain extenders, stabilizers, water, catalysts, surface-active substances, foam stabilizers, cell regulators, fillers, dyes, pigments, flame retardants, antistats, hydrolysis control agents and/or fungistatically and bacteriostatically active substances and mixtures thereof.

For the purposes of the present invention, any chemical entity known for a person skilled in the art and capable of fulfilling the abovementioned functions can in general be used as additive.

Stabilizers, the presence of which is optional for the purposes of the present invention, further the development of a regular cellular structure in the course of foam formation.

Examples include silicone-containing foam stabilizers, such as siloxane-oxyalkylene copolymers and other organopolysiloxanes. Also alkoxylation products of fatty alcohols, oxoprocess alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol, and also alkoxylation products of condensation products formed from formaldehyde and alkylphenols; formaldehyde and dialkylphenols; formaldehyde and alkylkresols; formaldehyde and alkylresorcinol; formaldehyde and aniline; formaldehyde and toluidine; formaldehyde and naphthol; formaldehyde and alkylnaphthol; and formaldehyde and bisphenol A; or mixtures of two or more thereof.

The amount which is used of the at least one stabilizer is generally in the range from 0.2 to 5 wt % and preferably in the range from 0.5 to 4.0 wt %, all based on the total weight of at least one polyol, stabilizer and optionally water.

Chain extenders, the presence of which is optional according to the present invention, are generally compounds having a molecular weight of 60 to 400 g/mol and 2 isocyanate-reactive hydrogen atoms. Examples thereof are butanediol, diethylene glycol, dipropylene glycol and ethylene glycol.

Optionally present chain extenders are generally used in an amount of 0 to 20 wt %, preferably of 2 to 15 wt %, based on the total weight of the at least one polyol and optionally present stabilizers and/or water.

Crosslinkers, the presence of which is optional according to the present invention serve for example to increase the crosslink density. Crosslinkers are generally compounds having a molecular weight of 60 to 400 g/mol and more than 2, for example 3, isocyanate-reactive hydrogen atoms. Glycerol is an example.

Optionally present crosslinkers are generally used in an amount of 0 to 20 wt % preferably of 2 to 15 wt %, based on the total weight of the at least one polyol and optionally present stabilizers and/or water. Optionally present flame retardants may be halogenated or halogen-free flame retardants. Preferred halogen-free flame retardants include for example ammonium polyphosphate, aluminum hydroxide, isocyanurate derivatives and carbonates of alkaline earth metals. Preference is given to using phosphates, for example triethyl phosphate, phosphonates, for example diethyl N,N-di(2-hydroxyethyl)aminomethylphosphonate, melamine, melamine derivatives such as, for example, melamine cyanurate and/or mixtures of melamine and expandable graphite. It will be appreciated that foams of the present invention are also obtainable when in addition to the preferably used halogen-free flame retardants further, halogenated flame retardants known in polyurethane chemistry are used/co-used, for example trikresyl phosphate, tris(2-chloroethyl)phosphate, tris(2-chloropropyl)phosphate, tetrakis(2-chloroethyl)ethylene diphosphate, dimethylmethane phosphonate, diethyl diethanolaminomethylphosphonate and also commercially available halogenated flame-retardant polyols. In addition to the halogen-substituted phosphates already mentioned, further organic or inorganic flame retardants can also be used, such as red phosphorus, aluminum oxide hydrate, antimony trioxide, arsenic oxide, calcium sulfate, corn starch and/or optionally aromatic polyesters, to flameproof the polyisocyanate polyaddition products.

Halogenated flame retardants are generally the flame retardants known from the prior art, for example brominated ethers (Ixol), brominated alcohols such as dibromoneopentyl alcohol, tribromoneopentyl alcohol and PHT-4-diol and also chlorinated phosphates, e.g., tris(2-chloroethyl)phosphate, tris(2-chloroisopropyl)phosphate (TCPP), tris(1,3-dichloroisopropyl)phosphate, tris(2,3-dibromopropyl)phosphate and tetrakis(2-chloroethyl)ethylene diphosphate.

Flame retardants are generally used in an amount of 0 wt % to 60 wt %, preferably 0 wt % to 50 wt % and more preferably 0 wt % to 40 wt %, all based on the total weight of the at least one polyol and optionally present stabilizer and/or water.

In a preferred embodiment, component A comprises at least one catalyst.

Preference for use as catalysts in component A and to produce the foams is given especially to compounds that have a substantial speeding effect on the reaction of reactive hydrogen atoms, especially of hydroxyl-containing compounds of the at least one polyol with the at least one polyisocyanate.

Useful catalysts include for example organometallic compounds, preferably organotin compounds, such as tin(II) salts of organic carboxylic acids, e.g., tin(II) acetate, tin(II) octoate, tin(II) ethylhexanoate and tin(II) laurate, and the dialkyltin(IV) salts of organic carboxylic acids, e.g., dibutyltin diacetate, dibutyltin dilaurate, dibutyltin maleate and dioctyltin diacetate. The organometallic compounds can be used alone or combined with strong basic amines. Examples are amidines, such as 2,3-dimethyl-3,4,5,6-tetrahydropyrimidine, tertiary amines which, like triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, bis(dimethyldiethylaminoethyl)ether, pentamethyldiethylenetriamine, tetramethyldiaminoethyl ether, bis(dimethylaminopropyl)urea, dimethylpiperazine, 1,2-dimethylimidazole, 1-azabicyclo-[3.3.0]octane, and aminoalkanol compounds, such as triethanolamine, triisopropanolamine, N-methyldiethanolamine, and N-ethyldiethanolamine and dimethylethanolamine serve as blowing catalysts which in addition to the gel reaction favor especially the reaction of the isocyanate with water. Diazabicycloundecane, 1,4-diazabicyclo-[2.2.2]octane (Dabco), 1-methylimidazole and preferably dimethylcyclohexylamine are used as gel catalyst.

The present invention can also utilize common general knowledge catalysts to augment the polyisocyanurate reaction (i.e., PIR catalysts), in which case a polyurethane is formed according to the present invention. Alkali and/or alkaline earth metal compounds, especially alkali metal salts, for example potassium acetate, potassium octanoate and potassium formate are used for example. The use of potassium acetate is preferred. Further alkali and/or alkaline earth metal compounds to be used according to the present invention include alkali metal hydroxide, such as sodium hydroxide, and alkali metal alkoxides, such as sodium methoxide and potassium isopropoxide, and also alkali metal salts of long-chain fatty acids having 10 to 20 carbon atoms and optionally lateral OH groups. Other known PIR catalysts are also possible, such as tris(dialkylaminoalkyl)-s-hexahydrotriazines, especially tris(N,N-dimethylaminopropyl)-s-hexahydrotriazine, tetraalkylammonium hydroxides, such as tetramethylammonium hydroxide.

It is particularly preferable to use dimethylcyclohexylamine as catalyst.

The optionally present at least one catalyst is generally used in an amount of 0.1 to 10 wt % and preferably of 0.5 to 5 wt %, based on the total weight of the at least one polyol and optionally present stabilizer and/or water.

The composition of the present invention for producing a rigid polyurethane foam also comprises at least one blowing agent as component A in addition to the at least one polyol having a molecular weight of not less than 1700 g/mol.

Chemical and/or physical blowing agents may be present in the composition of the present invention.

Preferred chemical blowing agents are water or carboxylic acids, especially formic acid. Chemical blowing agents are generally used in an amount of 0.1 to 10 wt %, especially of 0.5 to 7 wt %, based on the total weight of the at least one polyol and optionally present stabilizer and/or water.

It is preferable to use at least one physical blowing agent in the present invention. Physical blowing agents are compounds which are in a dissolved or emulsified state in the composition of the present invention and vaporize under the conditions of polyurethane formation. They include for example hydrocarbons, for example cyclopentane or a mixture comprising cyclopentane, halogenated hydrocarbons, and other compounds, for example perfluorinated alkanes, such as perfluorohexane, chlorofluorocarbons, and also ethers, esters, ketones and/or acetals. These are typically used in an amount of 1 to 30 wt %, preferably 2 to 25 wt % and more preferably 3 to 20 wt %, based on the total weight of at least one polyol and optionally present stabilizer and/or water.

The present invention therefore relates with preference to that composition according to the present invention wherein the blowing agent is cyclopentane or a mixture comprising cyclopentane. For example, a mixture of cyclopentane and water can be used as blowing agent in the present invention.

### Component B:

The composition of the present invention comprises as component B at least one polyisocyanate, wherein the at least one polyisocyanate B comprises from 11 to 39.5 wt % of a polyisocyanate prepolymer based on at least one polyether polyol having an OH number of at least 100 mg KOH/g.

For the purposes of the present invention, the term “polyisocyanate” is to be understood as meaning a compound having two or more isocyanate groups. Useful organic polyisocyanates include for example aliphatic, cycloaliphatic and especially aromatic di- or polyisocyanates. Specific examples are aliphatic diisocyanates, such as 1,6-hexamethylene diisocyanate, 2-methyl-1,5-pentamethylene diisocyanate, 2-ethyl-1,4-butylene diisocyanate or mixtures of 2 or more of said C6-alkylene diisocyanates, 1,5-pentamethylene diisocyanate and 1,4-butylene diisocyanate, cycloaliphatic diisocyanates, such as 1-isocyanato-3,3,5-trimethyl-5-isocyanatomethylcyclohexane (isophorone diisocyanate), 1,4-cyclohexane diisocyanate, 1-methyl-2,4- and -2,6-cyclohexane diisocyanate and also the corresponding isomeric mixtures, 4,4′-, 2,4′- and 2,2′-dicyclohexylmethane diisocyanate and also the corresponding isomeric mixtures and preferably aromatic diisocyanates, such as 1,5-naphthylene diisocyanate (1,5-NDI), 2,4- and 2,6-tolylene diisocyanate (TDI) and also mixtures thereof, 2,4′-, 2,2′-, and preferably 4,4′-diphenylmethane diisocyanate (mMDI) and also mixtures of two or more of these isomers, polyphenyl polymethylene polyisocyanates (polymeric MDI, pMDI) having two or more aromatic systems, mixtures of 2,4′-, 2,2′- and 4,4′-diphenylmethane diisocyanates and polyphenyl polymethylene polyisocyanates (crude MDI), mixtures of crude MDI and tolylene diisocyanates, polyphenyl polyisocyanates, carbodiimide-modified liquid 4,4′- and/or 2,4-diphenylmethane diisocyanates and 4,4′-diisocyanato-1,2-diphenylethane. It is particularly preferable to use isocyanates that are liquid at 25° C.

It is an essential aspect of the present invention that the polyisocyanate component B comprises 11 to 39.5 wt %, preferably 12 to 35 wt %, more preferably 12.5 to 33 wt % of a polyisocyanate prepolymer, based on at least one polyether polyol having an OH number of at least 100 mg KOH/1 g.

In another embodiment, the polyisocyanate component B comprises 40 to 100 wt %, preferably 45 to 100 wt %, more preferably 50 to 100 wt % and most preferably 100 wt % of a polyisocyanate prepolymer.

Polyisocyanate prepolymers per se are known from the prior art. They are prepared in a known manner by reacting above-described polyisocyanates, for example at temperatures of about 80° C., with compounds having isocyanate-reactive hydrogen atoms, preferably with polyols, to form polyisocyanate prepolymers. The polyol-polyisocyanate ratio is preferably chosen such that the NCO content of the prepolymer is in the range from 8 to 35%, preferably in the range from 15 to 30% and more preferably in the range from 20 to 30%.

Useful polyols for preparing the polyisocyanate prepolymers include in principle the polyols mentioned above in respect of component A, i.e., polyether polyols having an OH number of at least 100 mg KOH/g. The prepolymers which are used according to the present invention are prepared using, for example, polyether polyols based on glycerol as starter compound alkoxylated with ethylene oxide and/or propylene oxide. The polyisocyanate prepolymers are preferably prepared using dipropylene glycol and/or polypropylene glycol.

According to the present invention, component B utilizes polyether polyols having an OH number of at least 100 mg KOH/g. The hydroxyl number (OH number) of the polyether polyols is preferably for example in the range from 100 to 600 mg KOH/g or preferably in the range from 150 to 500 mg KOH/g and even more preferably in the range from 200 to 450 mg KOH/g.

The functionality of the polyetherol used in components B is for example in the range from 1.5 to 6, preferably in the range from 1.7 to 5 and more preferably in the range from 1.9 to 4.5.

In a further embodiment, the polyols used for preparing the polyisocyanate prepolymers can in principle be the polyols mentioned above in respect of components A, i.e., polyetherols and/or polyesterols. The preferred prepolymers of the present invention are prepared by reacting these polyetherols with appropriate di- and/or polyisocyanates. Preferably 4,4′-mMDI, pMDI or a mixture thereof is reacted with an appropriate polyol, preferably with a polypropylene glycol.

Polyisocyanate prepolymers preferably used according to the present invention have a functionality of for example 1.0 to 4.0, preferably 2.0 to 3.0.

In a further embodiment which is preferred according to the present invention, component B utilizes a mixture of at least one polyisocyanate prepolymer and at least one polyisocyanate having the aforementioned prepolymer content. Preferred mixtures comprise for example pMDI and/or mMDI, in addition to the polyisocyanate prepolymer.

In a very particularly preferred embodiment of the present invention, component B comprises a prepolymer of 4,4′-mMDI, dipropylene glycol and polypropylene glycol (OH number 250 mg KOH/g), having an NCO content of 22.9% and an average functionality of 2.05; the prepolymer content is 31%,

or
a prepolymer of 4,4′-mMDI, pMDI and polypropylene glycol (OH number 250 mg KOH/g) having an NCO content of 28.5% and an average functionality of 2.4; the prepolymer content is 13%,
optionally
optionally in admixture with further polyisocyanates, such as
a mixture of 4,4′-diphenylmethane diisocyanate with higher-functional oligomers and isomers, having an NCO content of 31.5% and an average functionality of about 2.7
or
a carbodiimide-modified 4,4′-mMDI, having an NCO content of 29.5% and an average functionality of 2.2. The composition of the present invention generally comprises components A and B in such amounts that the isocyanate index is generally in the range from 50 to 175, preferably in the range from 80 to 160, more preferably in the range from 100 to 150, for example 120±1.

The present invention also relates to a rigid polyurethane foam obtainable by reacting the composition of the present invention.

The present invention also relates to a process for producing a rigid polyurethane foam of the present invention from a composition of the present invention, comprising at least the steps of:

(1) contacting components A and B to obtain a reaction product, and
(2) foaming up the reaction product obtained in step (1).

Preferably in accordance with the invention, and in a manner known to the skilled person, steps (1) and (2) take place simultaneously—that is, while components A and B are reacting with one another, the reaction product formed undergoes foaming. It is also possible for foaming of the reaction product to continue after the end of reaction as well.

The rigid foams of the present invention are advantageously produced by the one-shot process, for example using high-pressure or low-pressure technology. It will turn out to be particularly advantageous to use the two-component process to contact components A and B (step 1).

Components A and B are typically mixed and reacted at a temperature of 15 to 80° C., preferably of 20 to 60° C. and especially of 20 to 35° C., optionally under elevated pressure. Mixing can be effected mechanically using a stirrer, using a stirred screw or by high-pressure mixing in a nozzle or mix head.

The foaming as per step (2) of the present invention is subsequently effected by expanding the incorporated blowing agent under the stated reaction conditions. Foaming can be effected in appropriate molds in order that the rigid polyurethane foam of the present invention may be obtained in corresponding geometric shapes.

The density of rigid polyurethane foams of the present invention is preferably in the range from 20 to 200 kg/m³, more preferably in the range from 30 to 100 kg/m³ and especially in the range from 35 to 80 kg/m³.

The rigid polyurethane foams of the present invention preferably have a compressive strength of greater than 0.10 N/mm² and a thermal conductivity of less than 27 mW/m*K at 23° C. mean temperature.

The rigid polyurethane foam of the present invention is preferably used in the present invention as insulation, preferably as pipe insulation.

The present invention therefore further relates to the use of a rigid polyurethane foam of the present invention for insulation, preferably for pipe insulation.

The present invention also relates to an insulated pipe comprising a rigid polyurethane foam of the present invention.

The production of insulated pipes is generally familiar to a person skilled in the art. In an example of a possible process, the composition of the present invention of components A and B is filled, preferably continuously, into a tubularly preshaped, optionally multi-ply, preferably diffusion-inhibiting film surrounding a media pipe with an annular gap to be filled to produce the rigid polyurethane foam, with the components A and B reacting together and the reaction product foaming up to form the rigid polyurethane foam, and the rigid polyurethane foam surrounded by the film is led, preferably continuously, into an extruder, preferably into a ring extruder, and a thermoplastic material is extruded onto the film. The insulated pipe formed can then be cooled, by being passed through a cooling water bath, for example.

The present invention therefore further provides a process for producing an insulated pipe, preferably the insulated pipe of the present invention, comprising at least one rigid polyurethane foam of the present invention, where the composition of the present invention comprising components A and B for producing the rigid polyurethane foam is filled, preferably continuously, into a tubularly preshaped, optionally multi-ply, preferably diffusion-inhibiting film surrounding a media pipe with an annular gap to be filled, with components A and B reacting with one another and with the reaction product foaming to form the rigid polyurethane foam, and the rigid polyurethane foam surrounded by the film is led, preferably continuously, into an extruder, preferably into a ring extruder, and a thermoplastic material is extruded onto the film.

Since winding up the insulated pipes is easily possible owing to the high flexibility of the rigid polyurethane foam of the present invention, there is no need to join the pipes which are preferably produced continuously. It is thus possible to produce insulated pipes having a length of more than 50 m, preferably more than 200 m and especially more than 400 m.

The media pipe may be based for example on the following materials: metals, especially copper, stainless steel, unalloyed steel and aluminum and also plastics, especially crosslinked polyethylene (PEX). Media pipe wall thickness can typically be in the range from 0.5 mm to 25 mm. Media pipe overall diameter is generally in the range from 25 to 1000 mm and preferably in the range from 25 to 400 mm. The rigid polyurethane foam may adhere to the media pipe. Alternatively, customary release agents can be applied to the outer surface of the media pipe to prevent adherence of the rigid polyurethane foam to the media pipe.

The jacketing pipe may be based for example on the following materials: thermoplastics, especially HDPE and LDPE, and metals, for example wind-and-fold sheeting.

After passing through the cooling water bath, the insulated pipe can be wound up on drums above 1 m, preferably above 1.5 m and most preferably above 2 m in diameter. This creates high tensile loads on the outside surface and high compressive loads on the inside surface, which the rigid polyurethane foam of the present invention is easily able to bear. The rigid polyurethane foam of the present invention has sufficient flexibility to withstand the tensile load and sufficient compressive strength to withstand the compressive load.

The jacketing pipe can consist of one or more layers, for example of the optionally diffusion-inhibiting, optionally multi-ply film described at the outset and a further, preferably thicker layer of preferably thermoplastic. The jacketing pipe overall wall thickness including the film where appropriate is generally in the range from 1 mm to 25 mm.

### EXAMPLES

Inventive rigid polyurethane foams 1, 2, 3 and 4 and comparative foams V5, V6, V7 and V8 are produced. The isocyanates and the isocyanate-reactive components were foamed up together with the blowing agents, catalysts and all further admixtures at an index of 120±1. For foaming, a laboratory stirrer was used in a beaker at a rate of 1400 revolutions per minute for 10 seconds. This beaker test is used to determine the reaction times and the free rise density. Further parameters are determined on foamed structures obtained by pouring the reaction mixture stirred in the beaker into a box mold measuring 200×200×70 mm³.

The formulations were all adjusted to a fiber time of 90±10 s and a free rise density of 52±3 g/l.

### Methods of Measurement

Compressive strengths and moduli of elasticity in compression were measured on the rigid polyurethane foams to DIN 53421/DIN EN ISO 604.

Thermal conductivity was determined after 24 hours' storage under standard conditions. The test specimens had the dimensions of 200×200×30 mm³. Thermal conductivity is then determined at a mean temperature of 23° C. using a Hesto A50 plate-type heat flow meter.

Closed-cell content was determined using a gas displacement pyknometer in line with DIN EN ISO 4590.

The 3 point bending test was carried out in line with DIN 53423. The deflection limit is 30 mm. Flexural strength was calculated at peak force. Deflection at break is the deflection in the middle of the test specimen at the moment of breaking.

Formulations and test results are shown in Table 1. The table shows that using a rigid PU foam system of the present invention distinctly improves deflection at break and hence foam flexibility. This enhanced flexibility was achieved without sacrificing the thermal conductivity and compressive strength, the most important properties of a rigid polyurethane foam system.

TABLE 1

| Test | 1 | 2 | 3 | 4 | V5 | V6 | V7 | V8 |
|---|---|---|---|---|---|---|---|---|
| | Component A | | | | | | | |
| Polyether a1 | 40 | 40 | 40 | 40 | 40 | 48.5 | 40 | 40 |
| Polyether a2 | 30 | 30 | 30 | 30 | 30 | 48.5 | 30 | 30 |
| Polyether a3 | 27 | 27 | 27 | 27 | 27 | — | 27 | 27 |
| Stabilizer | 2 | 2 | 2 | 2 | 2 | 2 | 2 | 2 |
| Water | 1 | 1 | 1 | 1 | 1 | 1 | 1 | 1 |
| Sum total | 100 | 100 | 100 | 100 | 100 | 100 | 100 | 100 |
| DMCHA | 2.5 | 2 | 2 | 2 | 2 | 1.2 | 1.5 | 2 |
| Cyclopentane | 9 | 8.5 | 8.5 | 8 | 8.5 | 7.5 | 8 | 8 |
| | Component B, isocyanate index 120 ± 1 | | | | | | | |
| Isocyanate 1 | — | 50 | — | — | — | 100 | 100 | — |
| Isocyanate 2 | — | — | 50 | — | 67 | — | — | 100 |
| Isocyanate 3 | 100 | 50 | 50 | — | 33 | — | — | — |
| Isocyanate 4 | — | — | — | 100 | | — | — | — |
| Sum total | 100 | 100 | 100 | 100 | 100 | 100 | 100 | 100 |
| including prepolymer | 31 | 15.5 | 15.5 | 13 | 10.3 | 0 | 0 | 0 |
| | Foam properties at core pipe densities 65 ± 6 kg/m³ | | | | | | | |
| Compressive test | | | | | | | | |
| Compressive strength (N/mm²) | nd | 0.235 | 0.223 | 0.251 | 0.266 | 0.227 | 0.243 | 0.224 |
| Modulus of elasticity (N/mm²) | 5.40 | 7.23 | 6.67 | 8.45 | 9.02 | 6.58 | 7.22 | 7.03 |
| 3 point bending test | | | | | | | | |
| Flexural strength (N/mm²) | 0.39 | 0.44 | 0.37 | 0.52 | 0.54 | 0.52 | 0.44 | 0.37 |
| at deflection (mm) | 21.5 | 21.0 | 21.8 | 17.1 | 16.4 | 18.4 | 15.4 | 15.9 |
| Deflection at break (mm) | 26.3 | 24.3 | 27.0 | 23.0 | 18.0 | 18.0 | 15.3 | 17.0 |
| Closed-cell content (%) | 90 | 91 | 89 | 90 | 91 | 92 | 89 | 89 |
| Thermal conductivity (mW/m * K) | 23.0 | 23.2 | 23.4 | 24.8 | 25.0 | 23.4 | 23.4 | 25.5 |

Unless stated otherwise, the values are given in wt %.

The following components were used:
Polyether a1: started with glycerol, alkoxylated with PO/EO, OH number 35 mg KOH/g, functionality 2.7, mean molecular weight 4350 g/mol
Polyether a2: started with TDA (tolylenediamine), alkoxylated with EO and PO, OH number 390 mg KOH/g, functionality 3.8, mean molecular weight 530 g/mol
Polyether a3: started with sucrose, pentaerythritol and diethylene glycol, alkoxylated with PO, OH number 403 mg KOH/g, functionality 3.9, mean molecular weight 545 g/mol
Stabilizer: polysiloxane stabilizer (L 6900 from Momentive)
DMCHA: dimethylcyclohexylamine
Isocyanate 1: IsoPMDI 92140 from BASF SE, mixture of 4,4′-diphenylmethane diisocyanate with higher-functional oligomers and isomers, with NCO content of 31.5% and mean functionality of about 2.7
Isocyanate 2: carbodiimide-modified 4,4′-mMDI, with NCO content of 29.5% and a mean functionality of 2.2
Isocyanate 3: quasi prepolymer of 4,4′-mMDI, dipropylene glycol and polypropylene glycol (OH number 250 mg KOH/g), with NCO content of 22.9% and a mean functionality of 2.05; the prepolymer content is 31%.
Isocyanate 4: quasi prepolymer of 4,4′-mMDI, pMDI and polypropylene glycol (OH number 250 mg KOH/g), with NCO content of 28.5% and a mean functionality of 2.4; the prepolymer content is 13%.

1. A composition, comprising:
(A) at least one polyol having a molecular weight of not less than 1700 g/mol and at least one blowing agent as a component A, and
(B) at least one polyisocyanate as a component B,
wherein the at least one polyisocyanate B comprises from 11 to 39.5 wt % of a polyisocyanate prepolymer, based on at least one polyether polyol having an OH number of at least 100 mg KOH/g.

2. The composition according to claim 1, wherein the component A comprises at least one polyol based on a compound selected from the group consisting of alcohols, sugar compounds, amines, condensation products of at least one amine, at least one aromatic compound and formaldehyde, and mixtures thereof.

3. The composition according to claim 1, wherein the blowing agent is cyclopentane or a mixture comprising cyclopentane.

4. The composition according to claim 1 wherein, the component A comprises a polyetherol mixture comprising at least one polyetherol a1 based on at least one trihydric alcohol, and at least one polyetherol a2 based on at least one amine.

5. The composition according to claim 1, wherein the component A comprises a polyetherol mixture comprising at least one polyetherol a1 based on at least one trihydric alcohol, at least one polyetherol a2 based on at least one amine and at least one polyetherol a3 based on at least one sugar compound.

6. The composition according to claim 1, having a polyisocyanate index in the range from 80 to 150.

7. The composition according to claim 1, wherein the component A further comprises at least one additive selected from the group consisting of chain extenders, crosslinkers, stabilizers, catalysts, surface-active substances, foam stabilizers, cell regulators, fillers, dyes, pigments, flame retardants, antistats, hydrolysis control agents, fungistatically active substances, bacteriostatically active substances and mixtures thereof.

8. A rigid polyurethane foam obtainable by reacting the composition according to claim 1.

9. A process for producing a rigid polyurethane foam according to claim 8 from, the process comprising:
(1) contacting a component A and a component B to obtain a reaction product, and
(2) foaming up the reaction product, to form a rigid polyurethane foam,
wherein:
the component A comprises at least one polyol having a molecular weight of not less than 1700 g/mol and at least one blowing agent; and
the component B comprises at least one polyisocyanate.

10. An insulation, comprising the rigid polyurethane foam according to claim 8.

11. The insulation of claim 10 which is a pipe insulation.

12. An insulated pipe, comprising the rigid polyurethane foam according to claim 8.

13. A process for producing an insulated pipe, the process comprising:
filling a composition comprising components A and B into a tubularly preshaped film surrounding a media pipe with an annular gap to be filled, such that the components A and B react with one another and a reaction product undergoes foaming to form the rigid polyurethane foam according to claim 8;
transferring the rigid polyurethane foam surrounded by the film into an extruder; and
extruding a thermoplastic material onto the film,
wherein:
the component A comprises at least one polyol having a molecular weight of not less than 1700 g/mol and at least one blowing agent; and
the component B comprises at least one polyisocyanate.

14. The composition of claim 1, which is suitable for producing a rigid polyurethane foam.
